(19) United States
(12) Patent Application Publication
(10) Pub. No.: US 2015/0039385 A1
(43) Pub. Date: Feb. 5, 2015

(54) SYSTEM AND METHOD FOR LIQUIDATION MANAGEMENT OF A COMPANY

(71) Applicant: America Express Travel Related Services Company, Inc., New York, NY (US)

(72) Inventors: Brendan McCormick, Brooklyn, NY (US); Sangarsh Nigam, Jersey City, NJ (US)

(73) Assignee: American Express Travel Related Services Company, Inc., New York, NY (US)

(21) Appl. No.: 13/957,343

(22) Filed: Aug. 1, 2013

Related U.S. Application Data
(63) Continuation of application No. 13/957,331, filed on Aug. 1, 2013.

(51) Int. Cl. G06Q 10/06

(52) U.S. Cl. CPC G06Q 10/0635
USPC 705/7.28

(57) ABSTRACT

The present disclosure relates to a tool for identifying the probability of liquidation of a company. The system may be configured to collect indicators of liquidation data from a plurality of companies. The system may analyze the indicators of liquidation data to determine placement of a company of the plurality companies along a bankruptcy timeline. The system may mitigate a downside risk to a financial institution based on the placement. The computer based system may be configured to determine if a company has entered a bankruptcy proceeding. Term data may be scraped from a website, such as PACER, comprising legal proceeding data associated with the company for targeted terms. The computer based system may be configured to collect financial indicators pertinent to the bankruptcy proceeding from financial reports, analyze based on the identified targeted terms, the financial indicators.

### CROSS REFERENCE TO RELATED APPLICATION

This application is a continuation of, claims priority to and the benefit of, U.S. Ser. No. 13/957,331 filed Aug. 1, 2013 and entitled “SYSTEM AND METHOD FOR LIQUIDATION MANAGEMENT OF A COMPANY,” which is hereby incorporated by reference.

### FIELD

The present disclosure relates to managing liquidations, and more specifically to managing liquidations of a company through probability of liquidation models.

### BACKGROUND

Existing systems relating to liquidations usually suffer from one or more limitations including, for example, lack of comprehensive liquidations databases, inaccuracy of data in the databases, dearth of appropriate models for the databases, and/or manual processing of data leading to cost and time overruns. Moreover, the data on small companies has historically been lacking to create an accurate probability of liquidation. The existing systems typically use techniques to provide late indicators of liquidations and therefore it is often not possible to take corrective steps in advance. Therefore, there is a need for a system that builds a comprehensive, accurate, and reliable database of liquidations. Further, accurate and efficient probability of liquidation models are needed. Further, the database should be configured to be used to test and improve the probability of liquidation models.

### SUMMARY OF THE DISCLOSURE

The present disclosure addresses the aforementioned deficiencies in prior systems. For instance, the present system improves upon existing systems and methods by providing a tool for predicting the liquidation of a company. For instance, according to various embodiments, a computer based system is configured to collect indicators of liquidation data from a plurality of companies and data repositories, and based on the indicators of liquidation data, designate and/or place a company of the plurality companies along a bankruptcy timeline, and/or mitigate downside risk to a financial institution based on the placement.

According to various embodiments, the indicators of liquidation data are populated to a database by extracting, such as through scraping, data from an internet website of legal proceedings associated with the company for targeted terms using a website crawler. The indicators of liquidation data are populated to a database by scraping an internet website of news articles associated with the company for at least one key term and targeted phases using a website crawler. This may occur in response to identifying a first indicator of liquidation.

According to various embodiments, the computer based system may be configured to determine if and/or that a company has entered a bankruptcy proceeding. In some scenarios, a bankruptcy proceeding may include a merger and acquisition (as these may indicate instability and/or lead to a default) and bankruptcies under any one of Chapters 7, 11, 12 or 13 of Title 11 (Bankruptcy Code′) of the United States Code. Utilizing a website crawler, term data may be scraped from a website, such as PACER, comprising legal proceeding data associated with the company for targeted terms. The computer based system may be configured to collect financial indicators pertinent to the bankruptcy proceeding from financial reports, and analyze based on the identified targeted terms, the financial indicators. The computer based system may be configured to predict a tribunal result of the bankruptcy proceeding. For instance, the computer based system may predict the likely outcome decided by the judge.

According to various embodiments, the computer based system may be configured to calculate expected losses associated with the company according to a formula. The formula may comprise an exposure, such as exposure to a financial institution, at the time of liquidation multiplied by a probability of company default multiplied by a probability of company liquidation given default multiplied by an expected recovery in the event of company liquidation.

According to various embodiments, the analyzing may include identifying that the company is associated with at least one of a chapter 11 bankruptcy; a chapter 7 bankruptcy, an acquisition and a merger. In response to a determination that the company is associated with the chapter 11 bankruptcy, the computer based system may periodically evaluate at least one of that a liquidation plan is to be filed and/or filed and that a re-organization plan is to be filed and/or filed. In response to a determination that a re-organization plan is filed, the computer based system may evaluate that the chapter 11 bankruptcy has been at least one of converted to the chapter 7 bankruptcy and emerged from bankruptcy.

According to various embodiments, the mitigating of downside risk may include collecting collateral from the company, reducing exposure to the company, modifying a collection strategy associated with the company and/or exiting a relationship with the company. Mitigating of downside risk may also include producing additional funding for the company. For instance, a financial institution may be in a position to lend money to a company which will increase its likelihood for a tribunal to allow the company to exit the bankruptcy proceeding without undergoing liquidation. The computer based system may be configured to approximate a final judgment of a tribunal based on at least one of financial modeling and events of the company occurring. The collecting of the indicators of liquidation data may be according to an asset model, a bond model, a financial model and/or a legal model. The bond model may be based on a bond price and a company characteristic. The bond model may be may be updated based on trading of bonds. The legal model may leverage data extracted from bankruptcy filings.

According to various embodiments, the computer based system may be configured to scrape filing data from the website comprising legal proceeding to determine that the company of a plurality of companies has entered the bankruptcy proceeding. The computer based system may be configured to store at least one of the scraped term data, the scraped filing data, the analysis and/or the prediction to a database. The prediction and/or the analysis may be periodically updated. The computer based system may be configured to test and improve itself based on historical data with known conclusions to achieve an error rate of the prediction over a predefined threshold. The computer based system may be configured to place the company on a risk alert based on the prediction being over a predefined threshold.

According to various embodiments, the computer based system may be configured to update an algorithm that supports the analyzing based on actual liquidations and available reported data prior to liquidation. The computer based system may be configured to store collected indicators of liquidation data to a database.

According to various embodiments, the computer based system may be configured to assign a customized probability of liquidation to the company of the plurality of companies. The computer based system may be configured to periodically update at least one of an assigned customized probability of liquidation and the placement of the company along the bankruptcy timeline. The computer based system may be configured to test and/or improve the computer-based system on historical data with known conclusions to achieve an error rate over a predefined threshold. The computer based system may be configured to place the company on a risk alert based on the placement of the company along the bankruptcy timeline.

### BRIEF DESCRIPTION OF THE DRAWINGS

The above and other advantages of the disclosure will be apparent upon consideration of the following detailed description, taken in conjunction with the accompanying drawings, in which like reference characters refer to like parts throughout, and in which:

FIG. 1 illustrates a liquidation management system environment for managing liquidation in accordance with various embodiments.

FIG. 2 illustrates a liquidation management system for managing liquidation in accordance with various embodiments.

FIG. 3 illustrates, through a flow diagram, a method for mitigating downside risk to a financial institution in accordance with various embodiments.

FIG. 4 illustrates, through a flow diagram, a method for generating recommendations for mitigating downside risk to a financial institution in accordance with various embodiments.

FIG. 5 illustrates, through a flow diagram, a method for building a probability of liquidations database in accordance with various embodiments.

FIG. 6 illustrates, through a flow diagram, a method for creating a probability of liquidations model in accordance with various embodiments.

FIG. 7 illustrates, through a flow diagram, a method for executing a legal process model of probability of liquidations in accordance with various embodiments.

FIG. 8 illustrates, through a flow diagram, a method for executing an asset model of probability of liquidations in accordance with various embodiments.

FIG. 9 illustrates, through a flow diagram, a method for determining a probability of liquidations for a company in accordance with various embodiments.

FIG. 10 illustrates an exemplary computer system for use in managing liquidations in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

A “company” as described in the present disclosure includes, but is not limited to, a corporation, a business entity other than a corporation, a debtor family, an individual debtor, a government agency such a municipal corporation and the like.

The description below is provided for the United States jurisdiction by way of example and not limitation. A person of ordinary skill in the art would recognize that the systems, methods, articles of manufacture, computer program products provided by the present disclosure may be implemented for other jurisdictions without departing from the spirit and scope of the present disclosure.

Liquidation of a company is generally a legal process. Various jurisdictions provide different procedures to complete the liquidation. For example, in the United States, a request for liquidation is usually filed under Chapters 7, 11, 12 or 13 of Title 11 (′Bankruptcy Code′) of the United States Code. The company filing for bankruptcy may be liquidated to recover liabilities of the company. A liquidation under a Chapter 7 bankruptcy filing involves appointment of a trustee who collects the non-exempt property of the company and sells the property. The proceeds from the sale are distributed to the creditors of the company. Generally, the bankrupt company is allowed to keep essential property; therefore, most Chapter 7 cases are “no asset” cases, meaning that there are not sufficient non-exempt assets to fund a distribution to creditors of the company. Bankruptcy under Chapter 11, Chapter 12, or Chapter 13 relates to a reorganization plan. The reorganization plan allows the company to keep some or all of property and to use future earnings to pay off the creditors. Chapter 11 filings by individuals are allowed, but are rare. Chapter 12 is similar to Chapter 13 but is available only to “family farmers” and “family fisherman” in certain situations.

A financial institution, which provide financial assistance to the company, needs information to assess risks involved in having a business relationship with the company. For example, the financial institution needs information on an exposure level with respect to the company. The exposure level is the highest potential loss to the financial institution in maintaining the business relationship with the company. Other factors in which need assessment include, but are not limited to, a probability of default by the company, and a probability of liquidation of the company given the default.

To determine probability of liquidation, probability of liquidation models have been developed. Probability of liquidation models include, without limitation, an asset model, a bond model, a financial model, a legal model, and a valuation model.

The asset model (also known as segmentation model) is based on historical average liquidation rates, asset size of the company, and risk rating of the company. The asset model may provide a full coverage for liquidation data; however, the asset model may not be specific for the company and may not be dynamic.

The financial model may provide the company specific probability of liquidation evaluation but at times may comprise limited coverage and may use outdated information.

The bond model may provide event specific probability for liquidations of companies. The bond model is global and dynamic. However, the bond model offers significantly limited coverage, in terms of the number for companies. For instance the bond model may be limited to large companies over a predetermined threshold. The bond model is further limited by the fact that it is based on the assumption that the market is rational and knowledgeable.

The legal model has the advantage that the legal events are highly predictive. The legal model provides coverage for private companies which are bankrupt. However, the legal model lacks automation. The signals of liquidations provided by the legal model are often late signals.

The valuation model is believed to be most robust and predictive to evaluate probability of liquidations. However, the valuation model is highly time consuming for well-trained individuals and difficult to quantify.

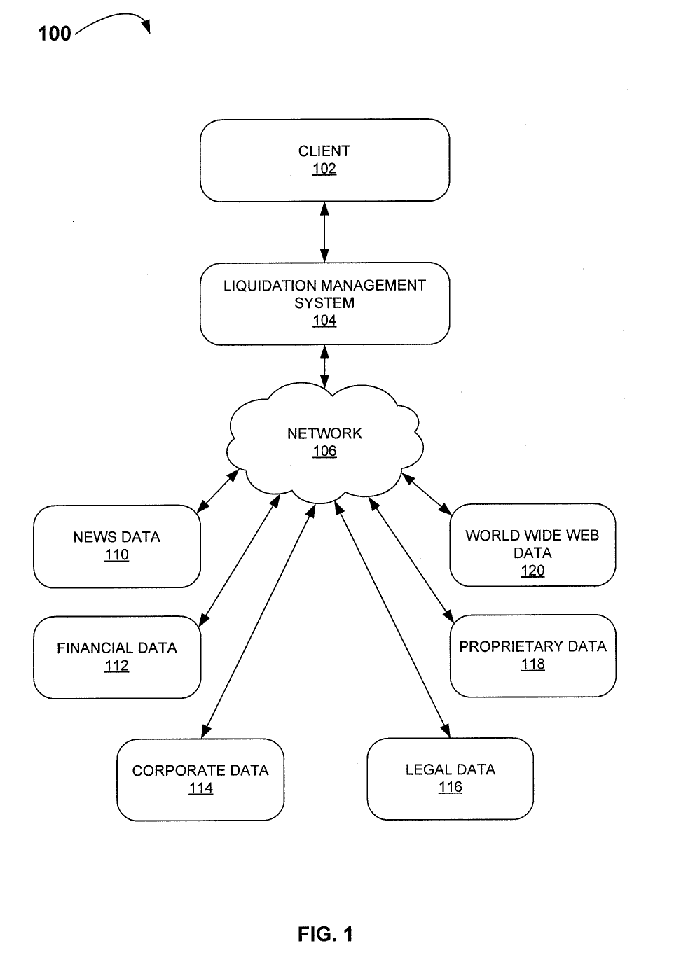

The present disclosure, in accordance with various embodiments, provides systems, methods, and articles of manufacture for creating a comprehensive liquidations database and accurate liquidation models for managing liquidations. Referring to FIG. 1, a system 100 for liquidation management is disclosed. A client 102 is communicatively coupled to the liquidation management system 104 for liquidation management of a company. The client 102 may be coupled directly or indirectly to the liquidation management system 104. The client 102 may be a personal computer, a laptop, a personal digital assistant, a mobile phone and the like. The client 102 may be located remotely from the liquidation management system 104 and communicatively coupled to the liquidation management system 104 through one or more communication networks.

The liquidation management system 104 is coupled to data sources through a network 106. The liquidation management system 104 may be provided as a service to third party clients or it may be used as a system internal to an organization. In various embodiments, the organization is a financial institution. The liquidation management system 104 may be implemented as a client, a server, or a personal computer.

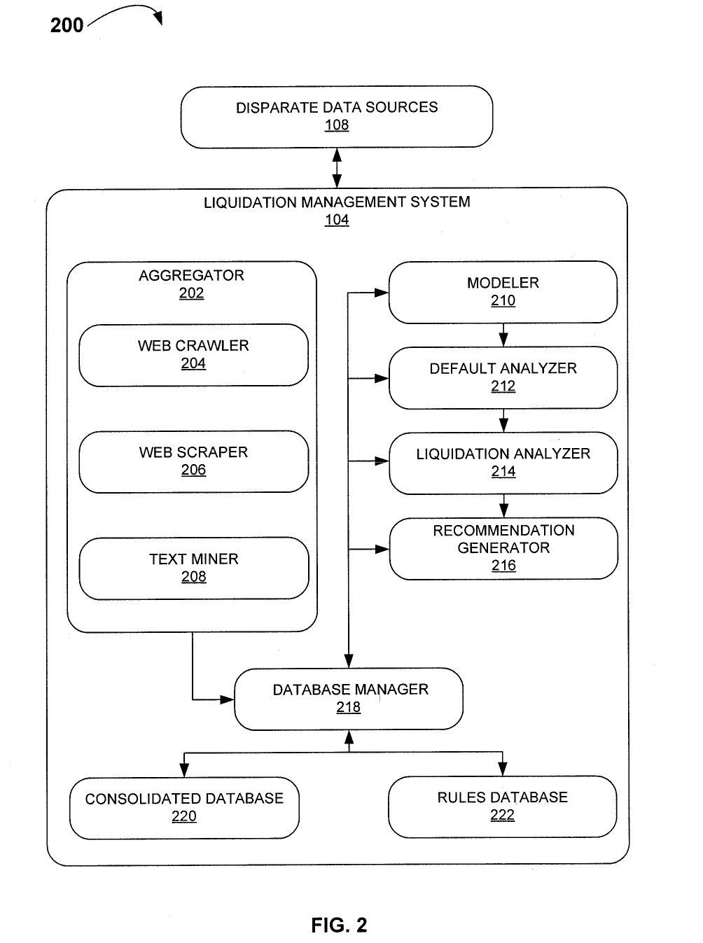

The data sources include, for example, news data 110, financial data 112, corporate data 114, legal data 116, proprietary data 118, world wide web data 120, and the like. Such ‘disparate’ data sources may lack compatibility with one another, may be inconsistent, incomplete, inefficient and/or inaccurate. The liquidation management system 104 may be configured (as described with reference to FIG. 2 below) to utilize data from the various data sources to achieve the objectives of the present disclosure, such as managing liquidation of the company.

The network 106 may be a wide area network (WAN), a local area network (LAN), an Ethernet, the Internet, an intranet, a cellular network, a satellite network, or any other suitable network for transmitting data. In various embodiments, the network 106 may include a combination of two or more of the aforementioned networks and/or other types of networks known in the art. The network 106 may be implemented as a wired network, a wireless network or a combination thereof. It should be appreciated that other types of networks are also contemplated herein. Further, data transmission among the client 102, the liquidation management system 104, and the data sources may occur over the network 106, in an encrypted or otherwise secure format, in any of a wide variety of known manners.

In accordance with various embodiments, the liquidation management system 104 collects indicators of liquidation data for the company from the data sources. The liquidation management system 104 may collect the indicators of liquidation data according to at least one of an asset model, a bond model, a financial model, a valuation model and/or a legal model. In accordance with various embodiments, the liquidation management system 104 may populate a database with the indicators of liquidation data by scraping an internet website of legal proceedings and/or an internet website of news articles, associated with the company for targeted terms using a website crawler. The targeted terms and/or phrases may be terms related to an ontology associated with liquidations.

In accordance with various embodiments, the liquidation management system 104 may assign a unique identification for the company and information related to the company, such as indicators of liquidation data, may be associated with the unique identification of the company.

The liquidation management system 104 places the company along a bankruptcy timeline, such as assigning a designation of what stage in the bankruptcy process and which type of bankruptcy the bankruptcy is, based on the indicators of liquidation data. The liquidation management system 104 further approximates a final judgment of a tribunal based on at least one of a financial modeling and events associated with the company. The liquidation management system 104 may further update an algorithm that supports the placing based on actual liquidations (of other companies) and available reported data prior to the liquidation of the company. In accordance with various embodiments, the liquidation management system 104 may identify that the company is associated with at least one of Chapter 11 bankruptcy; Chapter 7 bankruptcy, and/or an acquisition/merger. In response to a determination that the company is associated with Chapter 11 bankruptcy, the liquidation management system 104 may periodically evaluate that a liquidation plan is to be filed or has already been filed. The liquidation management system 104 may further evaluate that a re-organization plan is to be filed or has already been filed. When the reorganization plan has been filed, the liquidation management system 104 further evaluates that Chapter 11 bankruptcy has been converted to Chapter 7 bankruptcy or the company has emerged from bankruptcy.

The liquidation management system 104 is further configured to assign a customized probability of liquidation to the company. The assigned customized probability of liquidation and the placement of the company along the bankruptcy timeline may be updated periodically and/or at any time. The liquidation management system 104 is further configured to test and improve its predictions based on historical data with known conclusions to achieve an error rate below a predefined threshold. The liquidation management system 104 is further configured, using historical information, to increase the number of known conclusions captured. Stated another way the system may improve itself through a feedback loop. The liquidation management system 104 is further configured to place the company on a risk alert based on the placement of the company along the bankruptcy timeline.

The liquidation management system 104 may estimate losses to a financial institution in case the bankrupt company liquidates. The liquidation management system 104 may estimate the losses in accordance with an algorithm and/or formula that may include parameters such as an exposure at liquidation, a probability of company default, a probability of company liquidation given default, and an expected recovery amount in the event of a company liquidation.

The liquidation management system 104 may mitigate downside risk to the financial institution based on the placement of the company along the bankruptcy timeline. In various embodiments, the mitigating of downside risk may include, without limitation, at least one of collecting collateral from the company, reducing exposure to the company, modifying a collection strategy associated with the company and exiting a relationship with the company and or the like.

FIG. 2 illustrates the liquidation management system 104 for managing liquidation of a company in accordance with various embodiments. The liquidation management system 104 creates a consolidated database 218 from the data sources (110-120 shown in FIG. 1) for generating recommendations for a financial institution regarding liquidation of the company. The company may or may not be in a business relationship with the financial institution. In case the company is in a business relationship with the financial institution, the liquidation management system 104 may further generate expected losses and steps to mitigate the expected losses to the financial institution when the company liquidates. For instance, a payment plan may be established based on the findings of the liquidation management system 104. In case the company is not in a business relationship with the financial institution, the recommendations generated may be provided to third parties or may be used to generate reports and the like.

The liquidation management system includes an aggregator 202, a modeler 210, a default analyzer 212, a liquidation analyzer 214, a recommendation generator 216, a database manager 218, a consolidated database 220, and a rules database 222.

The aggregator 202 is communicatively coupled to the data sources and the database manager 218. The aggregator 202 is configured to create the consolidated database 220 from data obtained from the data sources. The aggregator 202 may include, but not limited to, a web crawler 204, a web scraper 206, a text miner 208 and the like. The web crawler 204 may browse the World Wide Web in an automated manner to provide updated data to the liquidation management system 104. The web scraper 206 may be configured for transforming unstructured data on the World Wide Web into structured data that can be stored and analyzed in the consolidated database 220. The text miner 208 may be configured to derive required information from the data available with the disparate data sources using text mining techniques. The required information may be stored in the consolidated database 218 for use by the liquidation management system 104.

The data aggregated by the data aggregator 202 from the disparate data sources may be provided to the database manager 218 which creates, and maintains the consolidated database 220. The database manager 218 is further configured to create and maintain the rules database 222. The rules database 222 may include algorithms, formulas, and rules, required by the liquidation management system 104. The modeler 210 determines a model to be applied on the data available in the consolidated database 220 based on the rules database 222. The default analyzer 212 determines a probability of default by the company based on the selected model and the rules applicable to that model. The liquidation analyzer 214 determines a probability of liquidation of the company given the default based on the probability of default and the applicable rules as per the selected model. The recommendation generator 216 is configured to generate recommendations based on the probability of liquidation of the company.

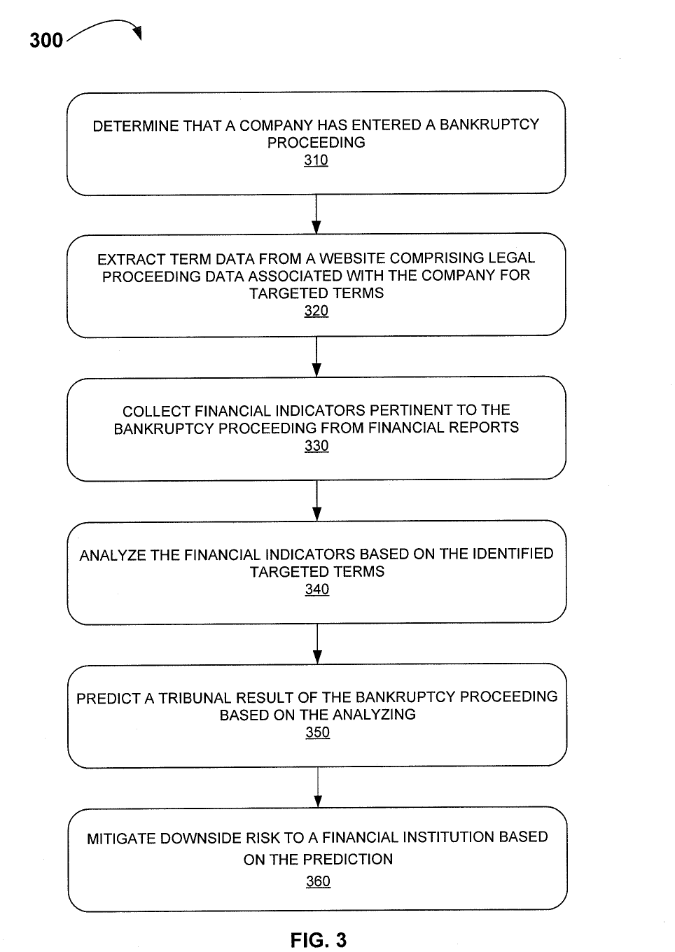

Referring to FIG. 3, a method 300 for liquidation management of a company is provided. At step 310, it is determined that the company has entered a bankruptcy proceeding. At step 320, a website having legal proceedings data associated with the company is scraped. At step 330, financial indicators pertinent to the bankruptcy proceedings may be collected from financial reports associated with the company. At step 340, the financial indicators may be analyzed based on the identified targeted terms. At step 350, a result of the bankruptcy proceeding in a tribunal may be predicted based on the analyzing. At step 360, downside risk to a financial institution may be mitigated based on the prediction. For instance, the financial institution may at least one of do nothing, contact the company, establish a payment, place the company of a hold, or sever ties with the company.

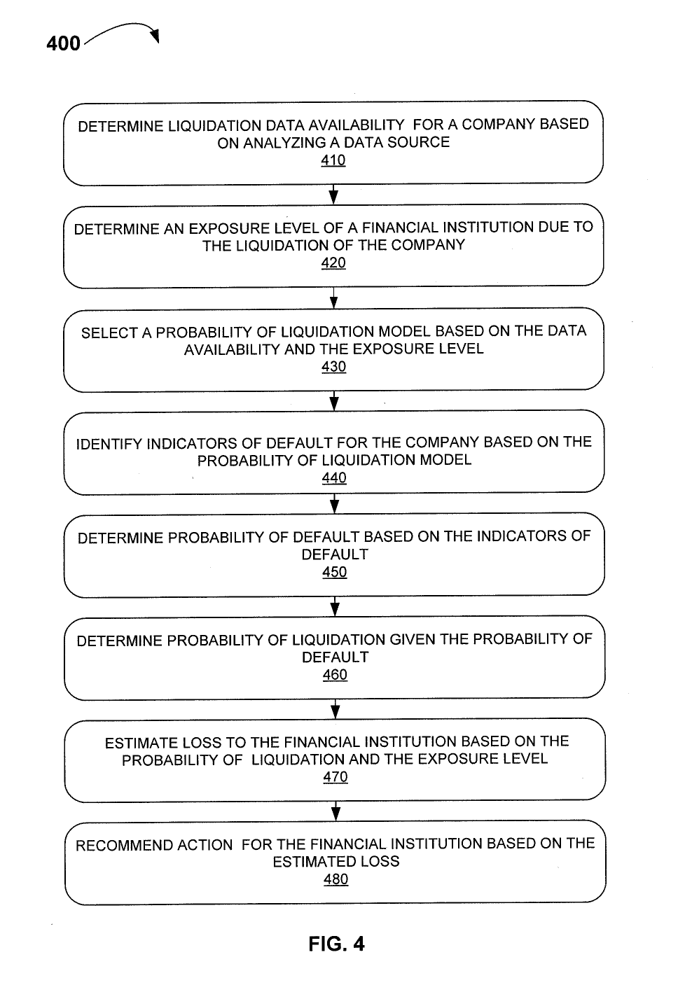

Referring to FIG. 4, a method 400 for generating recommendations for mitigating downside risk to a financial institution in response to liquidation of a company is provided. The method 400 begins at step 410, wherein a data source relating to liquidations data is analyzed to determine liquidations data availability for the company. In various embodiments, the data source is Public Access to Court Electronic Records (PACER), which is an electronic public access service of United States federal court documents. At step 420, an exposure level of the financial institution with respect to the company is determined. At step 430, a probability of liquidation model is selected based on the data availability and the exposure level. In various embodiments, the probability of liquidation model is selected from a plurality of probability of liquidation models. In various embodiments, the plurality of liquidation models comprises an asset model, a bond model, a legal process model, a valuation model, and a financial model. In another embodiment, a probability of liquidation model may be created based on the one or more of the plurality of liquidation models. At step 440, indicators of default for the company may be identified based on the selected or created probability of liquidation model. At step 450, a probability of default by the company may be determined based on the indicators of default. The indicators of default may have values indicating the probability of default for the company. At step 460, a probability of liquidation for the company given the probability of default of the company is determined. At step 470, loss to the financial institution is estimated based on the probability of liquidation and the exposure level. At step 480, an action may be recommended to the financial institution based on the estimated loss.

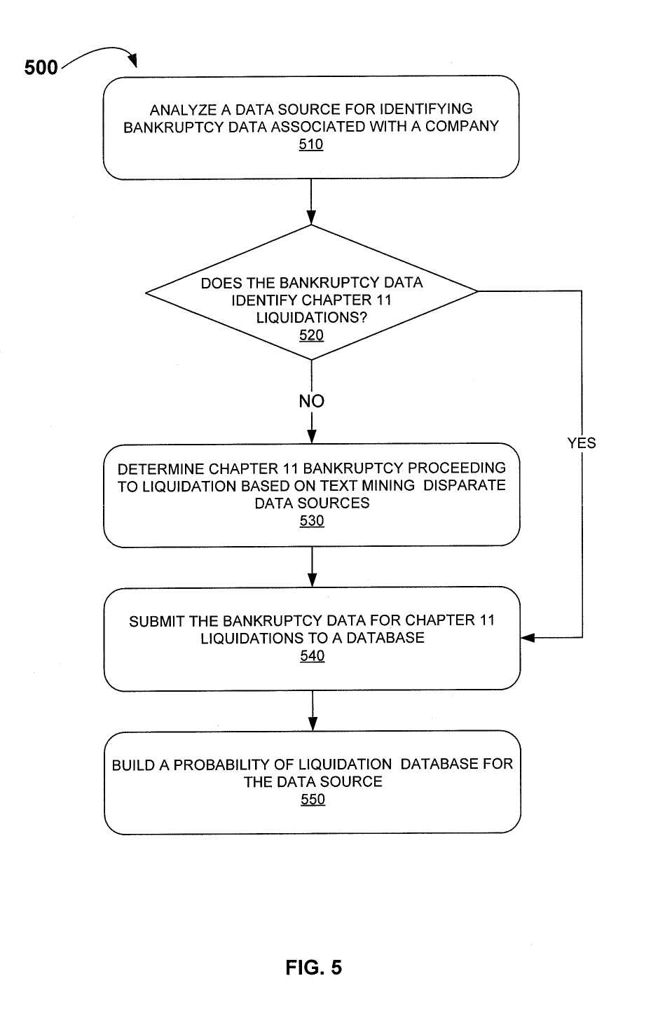

Referring to FIG. 5, a method 500 for building a probability of liquidation database is provided. The method 500 may begin at step 510, wherein a data source is analyzed for identifying bankruptcy data associated with the company. In various embodiments, the data source is a propriety data source, such as Public Access to Court Electronic Records (PACER), which is an electronic public access service of United States federal court documents. PACER does not identify liquidations for companies which file bankruptcy under Chapter 11. In various embodiments, the present disclosure removes this limitation by text mining the data source and identifying Chapter 11 liquidations. At step 510, it is determined whether or not the bankruptcy data identifies Chapter 11 liquidations. In response to a positive determination at step 520, the method 500 moves to step 540, wherein the bankruptcy data relating to Chapter 11 liquidations is submitted to a database. In response to a negative determination at step 520, the method 500 moves to step 530, wherein Chapter 11 bankruptcies which go into liquidations are identified based on text mining the data sources. At step 540, the text mined data is submitted to the database. At step 550, a consolidated database 218 for liquidations is built.

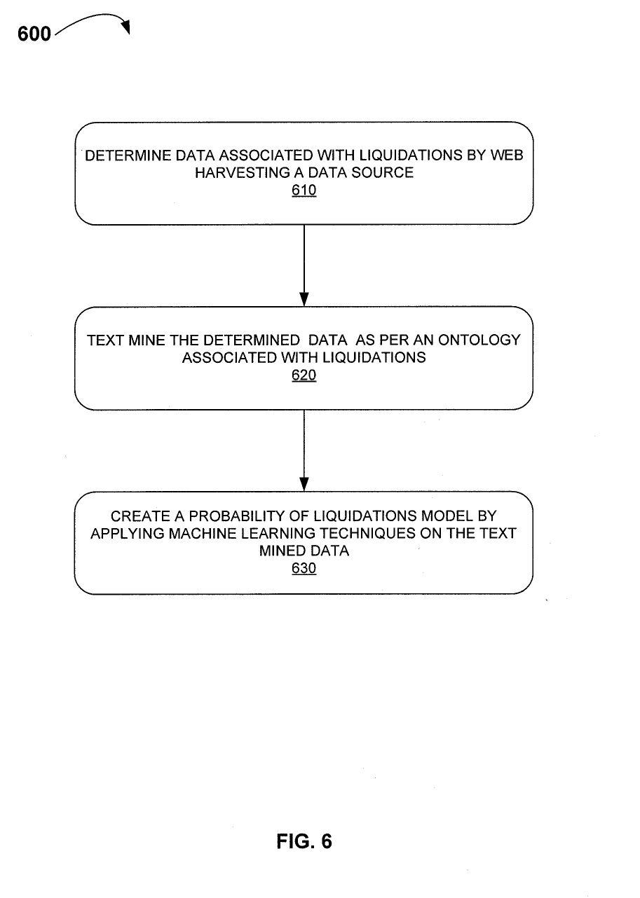

Referring to FIG. 6, a method 600 for creating a probability of liquidation model is provided. The method 600 begins at step 610, wherein data associated with liquidations is determined based on web harvesting a data source. In various embodiments, the data source is at least one of the data sources. At step 620, the determined data is text mined as per an ontology associated with liquidations. In various embodiments, the ontology includes, but not limited to, data relating to liquidation plan, section 363 sales, pre-packaged plan, stalking horse, Debtor In Possession (DIP) financing, cash collateral, and plan confirmation. At step 630, a probability of liquidations model is created by applying machine learning techniques on the text mined data. In various embodiments, the created plan is a function of a legal process model, an asset model, a bond model, a financial model, and/or a valuation model. In various embodiments, the created model corresponds to a random forest model.

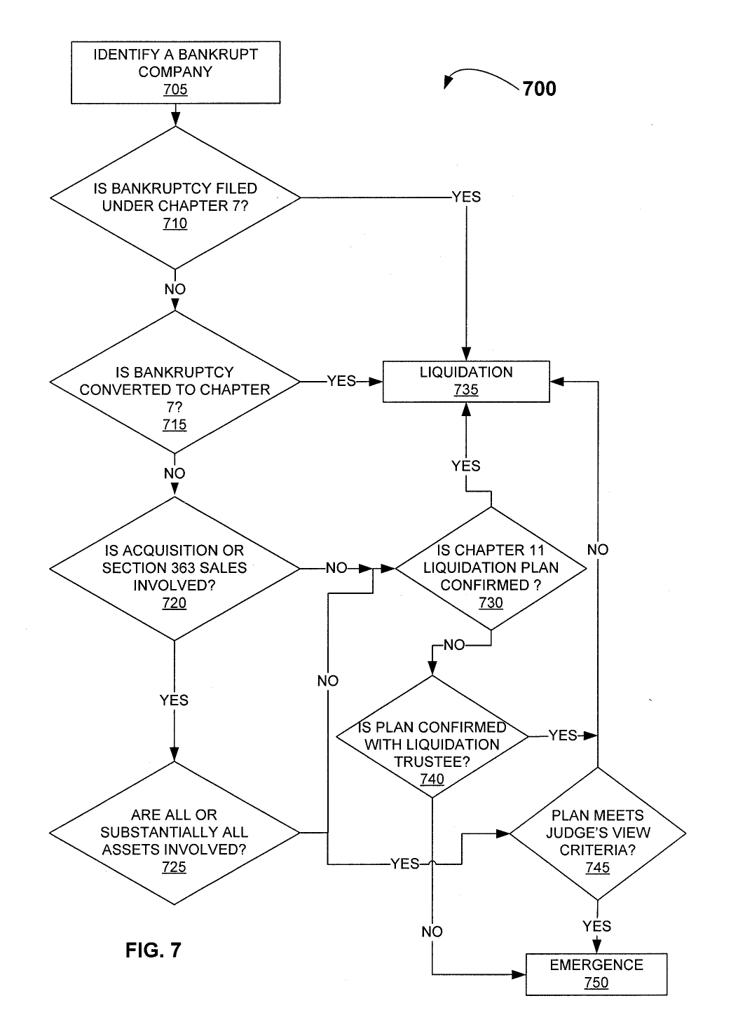

In reference to FIG. 7, a method 700 for executing a legal process model for managing liquidations is provided. The method 700 begins at step 705, wherein the bankrupt company is identified. At step 710, a determination is made whether or not the company has filed bankruptcy under Chapter 7. In response to a positive determination at step 710, the method 700 moves to step 735, wherein a conclusion is drawn that the company would liquidate. In response to a negative determination at step 710, the method 700 moves to step 715, wherein it is determined whether or not the bankruptcy filing has been converted to the Chapter 7 bankruptcy filing. In response to a positive determination at step 715, the method 700 moves to step 735. At step 735, a conclusion is drawn that the company would liquidate. In response to a negative determination at step 715, the method 700 moves to step 720. At step 720, a determination is made whether or not the bankruptcy filing involves an acquisition or Section 363 sales of the company. The Section 363 sale allows the company to sell assets ‘free and clear’ of the company's liabilities, and the 363 sale process usually starts with the debtor selecting a so-called ‘stalking horse’ bidder and negotiating an asset purchase agreement (APA). In response to a negative determination at step 720, the method moves to step 730. At step 730, a determination is made whether or not a liquidation plan under Chapter 11 has been confirmed. In response to a positive determination at step 730, the method 700 moves to step 735, wherein it is concluded that the company would liquidate. In response to a positive determination at step 720, the method 700 moves to step 725. At step 725, a determination is made whether or not all or substantially all assets of the company are involved in the acquisition or the Section 363 sales. In response to a negative determination at step 725, the method 700 moves to step 730. In response to a negative determination at step 730, the method moves to step 740. At step 740, a determination is made whether or not the liquidation plan for the company has been confirmed with a liquidation trustee. In response to a negative determination at step 740, the method 700 moves to step 750, wherein a conclusion is drawn that the company would emerge from the bankruptcy. In response to a positive determination at step 740, the method moves to step 735. In response to a positive determination at step 725, the method 700 moves to step 745, wherein a determination is made whether or not the Chapter 7 bankruptcy meets a judge's criteria. In response to a positive determination at step 745, the method 700 moves to step 750, wherein a conclusion of emergence of the company is drawn. In response to a negative determination at step 745, the method moves to step 735.

In response to a conclusion is drawn that the company would emerge from the bankruptcy the mitigation action may be to continue to monitor but take no action with respect to limiting financial resources of the company or contacting the company. Taking no action may include taking no remedial action (taking only actions that assist the company and/or monitoring). In this way, the relationship is not adversely affected in light of the bankruptcy proceeding.

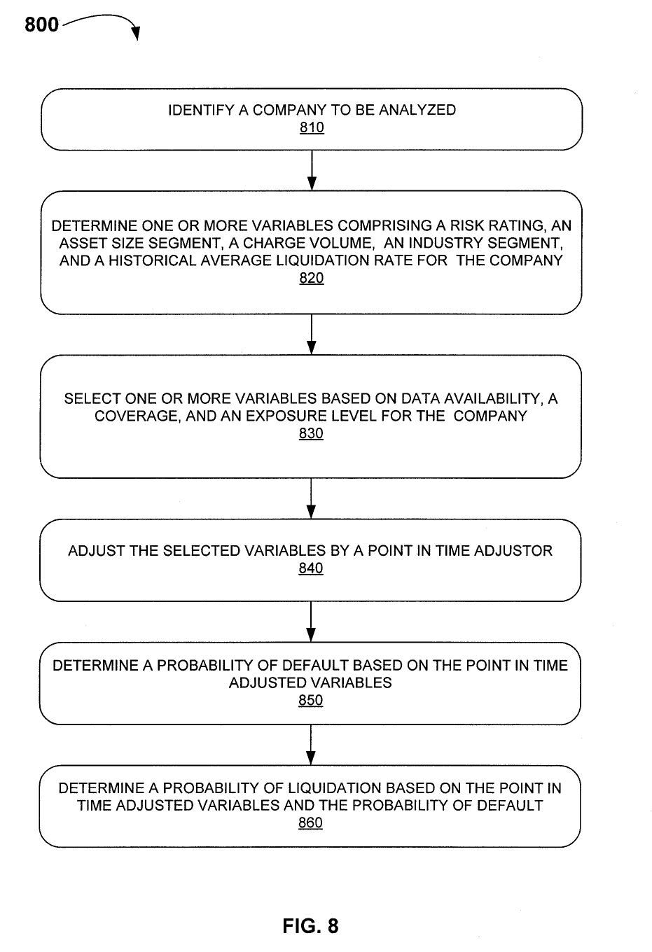

Referring to FIG. 8, a method 800 for executing an asset model of probability of liquidation is provided. The method 800 begins at step 810, wherein a company is identified to be analyzed for liquidation. At step 820, one or more variables related to the identified company are determined. In various embodiments, the one or more variable include, but not limited to, a risk rating, an asset size segment, a charge volume, an industry segment, a historical average liquidation rate and or the like for the company. At step 830, one or more variables are selected for the company based on data availability, coverage and an exposure level. At step 840, the selected variables are adjusted using a point in time adjustor. At step 850, a probability of default for the company is determined based on the point in time adjusted variables. The method 800 ends at step 860, wherein, a probability of liquidation for the company is determined based on the probability of default and the point in time adjusted variables.

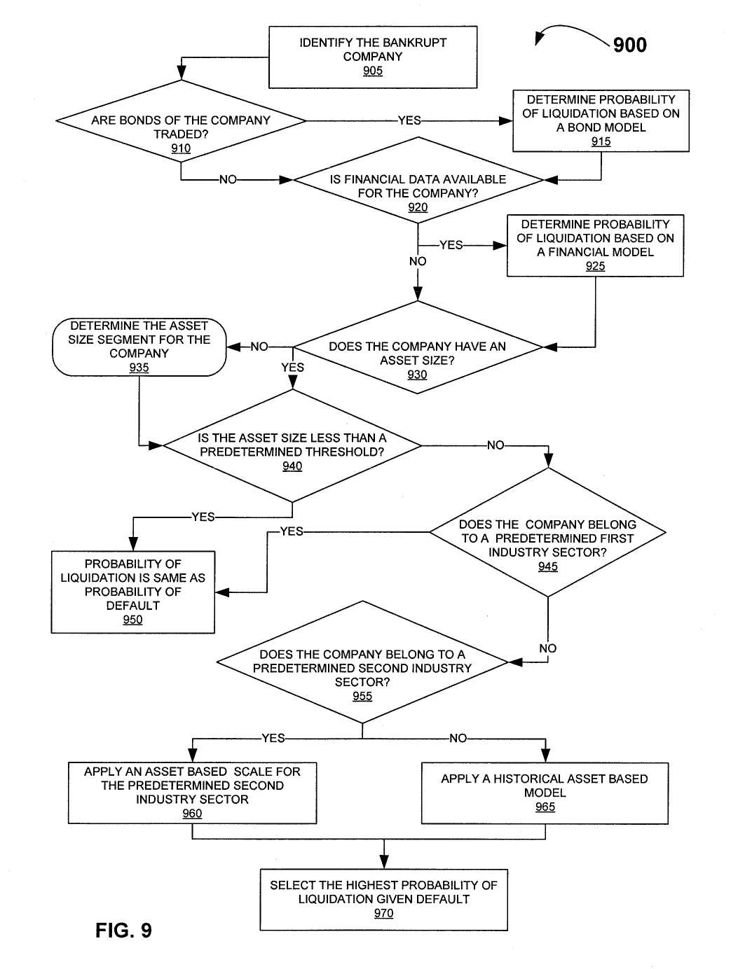

Referring to FIG. 9, a method 900 for determining a probability of liquidation for a company based on one or more probability of liquidation models is provided. The method 900 begins at step 905, wherein the bankrupt company is identified. At step 910, a determination is made whether or not bonds of the company are traded. In response to a positive determination at step 910, a probability of liquidation for the company is determined based on a bond model. In response to a negative determination at step 910 or after step 915, the method 900 moves to step 920. At step 920, a determination is made whether or not financial data is available for the company. In response to a positive determination at step 920, the method 900 moves to step 925, wherein a probability of liquidation for the company is determined based on a financial model. In response to a negative determination at step 920 or after step 925, the method 900 moves to step 930. At step 930, a determination is made whether or not the company has an asset size. In response to a negative determination at step 930, the method 900 moves to step 935, wherein the asset size segment for the company is determined. In response to a positive determination at step 930 or after step 935, the method 900 moves to step 940. At step 940, a determination is made whether or not the asset size of the company is less than a predetermined threshold. In response to a negative determination at step 940, the method 900 moves to step 945, wherein a determination is made whether the company belongs to a predetermined first industry sector. In various embodiments, the predetermined first industry sector is Cruise Lines sector. In response to a positive determination at step 945 or step 940, the method 900 moves to step 950. At step 950 a conclusion may be drawn that the probability of liquidation is same as the probability of default for the company. In response to a negative determination at step 945, the method 900 moves to step 955. At step 955, a determination is made whether or not the company belongs to a predetermined second industry sector. In various embodiments, the predetermined second industry sector is Furniture Stores sector. In response to a positive determination at step 955, the method 900 moves to step 960, wherein an asset based scale for the predetermined second industry sector is applied. In response to a negative determination at step 955, the method 900 moves to step 965, wherein a historical asset based model is applied. After steps 960 and 965, the method 900 moves to step 970, wherein the highest probability of liquidation given the default is selected from one or more probabilities of liquidation determined at previous steps of the method 900. The method 900 ends at step 970.

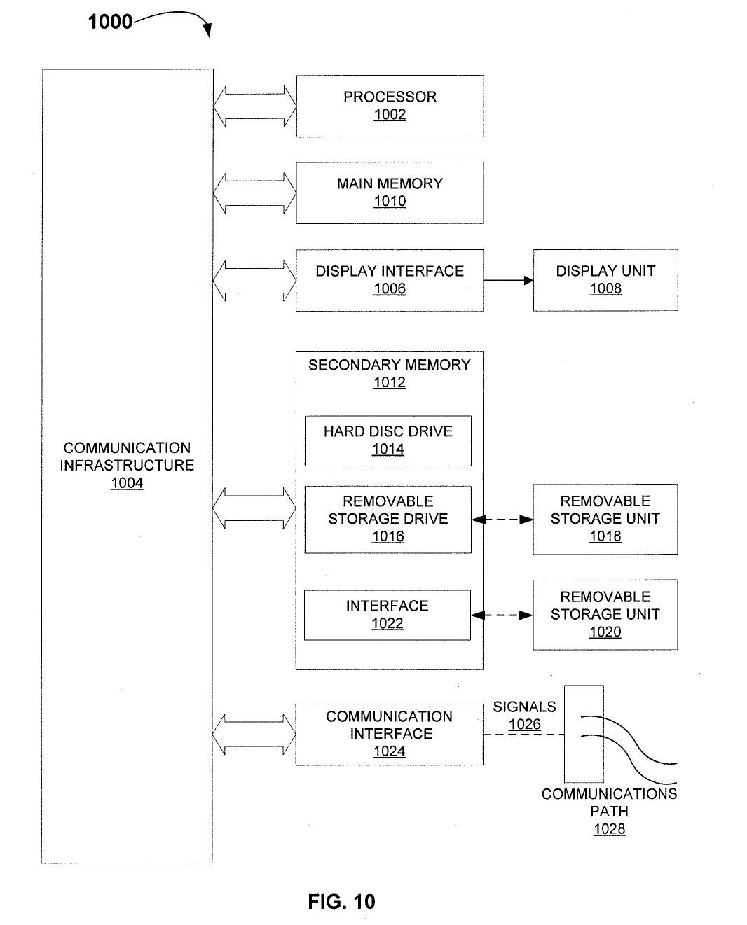

Referring to FIG. 10, an exemplary computer system 1000 for use in managing liquidations is provided. The computer system 1000 includes at least one processor, such as a processor 1002. The processor 1002 is connected to a communication infrastructure 1004, for example, a communications bus, a cross over bar, a network, and the like. Various software embodiments are described in terms of this exemplary computer system 1000. Having read this description, it will become apparent to a person skilled in the relevant art(s) how to implement the present disclosure using other computer systems and/or architectures.

The computer system 1000 includes a display interface 1006 that forwards graphics, text, and other data from the communication infrastructure 1004 (or from a frame buffer which is not shown in FIG. 10) for display on a display unit 1008.

The computer system 1000 further includes a main memory 1010, such as random access memory (RAM), and may also include a secondary memory 1012. The secondary memory 1012 may further include, for example, a hard disk drive 1014 and/or a removable storage drive 1016, representing a floppy disk drive, a magnetic tape drive, an optical disk drive, etc. The removable storage drive 1016 reads from and/or writes to a removable storage unit 1018 in a well-known manner. The removable storage unit 1018 may represent a floppy disk, magnetic tape or an optical disk, and may be read by and written to by the removable storage drive 1016. As will be appreciated, the removable storage unit 1018 includes a computer usable storage medium having stored therein, computer software and/or data.

In accordance with various embodiments of the present disclosure, the secondary memory 1012 may include other similar devices for allowing computer programs or other instructions to be loaded into the computer system 1000. Such devices may include, for example, a removable storage unit 1020, and an interface 1022. Examples of such devices may include a program cartridge and cartridge interface (such as that found in video game devices), a removable memory chip (such as an erasable programmable read only memory (EPROM)), or programmable read only memory (PROM) and associated socket, and other removable storage units 1020 and interfaces 1022, which allow software and data to be transferred from the removable storage unit 1020 to the computer system 1000.

The computer system 1000 may further include a communication interface 1024. The communication interface 1024 allows software and data to be transferred between the computer system 1000 and external devices. Examples of the communication interface 1024 include, but may not be limited to a modem, a network interface (such as an Ethernet card), a communications port, a Personal Computer Memory Card International Association (PCMCIA) slot and card, and the like. Software and data transferred via the communication interface 1024 are in the form of a plurality of signals, hereinafter referred to as signals 1026, which may be electronic, electromagnetic, optical or other signals capable of being received by the communication interface 1024. The signals 1026 are provided to the communication interface 1024 via a communication path (e.g., channel) 1028. The communication path 1028 carries the signals 1026 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 1016, a hard disk installed in hard disk drive 1014, the signals 1026, and the like. These computer program products provide software to the computer system 1000. The present disclosure is also directed to such computer program products.

Computer programs (also referred to as computer control logic) are stored in the main memory 1010 and/or the secondary memory 1012. Computer programs may also be received via the communication interface 1024. Such computer programs, when executed, enable the computer system 1000 to perform the features of the present disclosure, as discussed herein. In particular, the computer programs, when executed, enable the processor 1002 to perform the features of the present disclosure. Accordingly, such computer programs represent controllers of the computer system 1000.

In accordance with various embodiments, where the present disclosure is implemented using a software, the software may be stored in a computer program product and loaded into the computer system 1000 using the removable storage drive 1016, the hard disk drive 1014 or the communication interface 1024. The control logic (software), when executed by the processor 1002, causes the processor 1002 to perform the functions of the present disclosure as described herein.

Computer readable storage medium, such as non-transitory computer readable storage medium can be any apparatus that can contain, store, communicate, propagate, or transport the program for use by or in connection with the instruction execution system, apparatus, or device. The computer readable storage medium may include a propagated data signal with the computer-usable program code embodied therewith, either in baseband or as part of a carrier wave. The computer usable program code may be transmitted using any appropriate medium, including but not limited to the Internet, wire line, optical fiber cable, RF, etc.

Any suitable computer usable or computer readable medium may be utilized. The computer-usable or computer readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

These computer program instructions may also be stored in a computer-readable storage memory that can direct a computer or other programmable data processing apparatus to function in a particular manner, such that the instructions stored in the computer-readable storage memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

In another embodiment, the present disclosure is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present disclosure is implemented using a combination of both the hardware and the software.

The diagrams in FIGS. 1-10, illustrate the architecture, functionality, and operation of possible implementations of systems, methods, and articles of manufacture according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In various embodiments, components, modules, and/or engines of the system may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the form disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

In various embodiments, the processor can be configured for directing the steps of the methods described herein. In the detailed description herein, references to “various embodiments”, “one embodiment”, “an embodiment”, “in one aspect”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. As used herein, the term adjacent may mean in close proximity to, but does not necessarily require contact. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A method comprising:
collecting, by a computer-based system for prediction of liquidation, indicators of liquidation data from a plurality of companies;
placing, by the computer-based system and based on the indicators of liquidation data, a company of the plurality companies along a bankruptcy timeline; and
mitigating, by the computer-based system, downside risk to a financial institution based on the placement.

2. The method of claim 1, wherein the indicators of liquidation data are populated to a database by extracting an internet website of legal proceedings associated with the company for targeted terms using a website crawler.

3. The method of claim 1, wherein the indicators of liquidation data are populated to a database by extracting an internet website of news articles associated with the company for at least one key terms and targeted phases using a website crawler.

4. The method of claim 1, further comprising calculating, by the computer-based system, expected losses associated with the company according to a formula, wherein the formula comprises: an exposure at liquidation multiplied by a probability of company default multiplied by a probability of company liquidation given default multiplied by (one minus an expected recovery in the event of a company liquidation).

5. The method of claim 1, wherein the placing further comprises identifying that the company is associated with at least one of a chapter 11 bankruptcy; a chapter 7 bankruptcy, an acquisition and a merger.

6. The method of claim 5, further comprising, in response to a determination that the company is associated with the chapter 11 bankruptcy, periodically evaluating at least one of:
that a liquidation plan is at least one of: to be filed and filed, and
that a re-organization plan is at least one of: to be filed and filed.

7. The method of claim 6, further comprising, in response to a determination that a re-organization plan is filed, evaluating that the chapter 11 bankruptcy has been at least one of converted to the chapter 7 bankruptcy and emerged from bankruptcy.

8. The method of claim 1, wherein the mitigating of downside risk comprises at least one of collecting collateral from the company, reducing exposure to the company, modifying a collection strategy associated with the company, producing additional funding for the company, assisting the company and exiting a relationship with the company.

9. The method of claim 1, further comprising approximating, by the computer-based system, a final judgment of a tribunal based on at least one of financial modeling and events of the company occurring.

10. The method of claim 1, wherein the collecting the indicators of liquidation data is according to at least one of an asset model, a bond model, a financial model and a legal model.

11. The method of claim 10, wherein the bond model is based on a bond price and a company characteristic, and wherein the bond model is updated based on trading of bonds.

12. The method of claim 10, wherein the legal model leverages data extracted from bankruptcy filings.

13. The method of claim 1, further comprising updating an algorithm that supports the placing based on actual liquidations and available reported data prior to liquidation.

14. The method of claim 1, further comprising storing collected indicators of liquidation data to a database.

15. The method of claim 1, further comprising assigning a customized probability of liquidation to the company of the plurality of companies.

16. The method of claim 15, further comprising periodically updating at least one of an assigned customized probability of liquidation and the placement of the company along the bankruptcy timeline.

17. The method of claim 1, further comprising testing and improving the computer-based system on historical data with known conclusions to achieve an error rate over a predefined threshold.

18. The method of claim 1, further comprising placing the company on a risk alert based on the placement of the company along the bankruptcy timeline.

19. A system comprising:
a tangible, non-transitory memory communicating with a processor for prediction of liquidation,
the tangible, non-transitory memory having instructions stored thereon that, in response to execution by the processor, cause the processor to perform operations comprising:
collecting, by the processor, indicators of liquidation data from a plurality of companies;
placing, by the processor and based on the indicators of liquidation data, a company of the plurality companies along a bankruptcy timeline; and
mitigating, by the processor, downside risk to a financial institution based on the placement.

20. An article of manufacture including a non-transitory, tangible computer readable medium having instructions stored thereon that, in response to execution by a computer-based system for prediction of liquidation, cause the computer-based system to perform operations comprising:
collecting, by the computer-based system, indicators of liquidation data from a plurality of companies;
placing, by the computer-based system and based on the indicators of liquidation data, a company of the plurality companies along a bankruptcy timeline; and
mitigating, by the computer-based system, downside risk to a financial institution based on the placement.
